(19) United States
(12) Patent Application Publication
(10) Pub. No.: US 2010/0293956 A1
(43) Pub. Date: Nov. 25, 2010

(54) TURBINE FUEL NOZZLE HAVING PREMIXER WITH AUXILIARY VANE

(75) Inventor: Vaibhav Nadkarni, Bangalore (IN)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/470,293

(22) Filed: May 21, 2009

(51) Int. Cl. F02C 7/22

(52) U.S. Cl. 60/748; 60/740

(57) ABSTRACT

A fuel nozzle auxiliary vane comprising a vane mountable base comprising a fuel inlet, wherein the vane mountable base is configured to mount to a surface of a main vane disposed in an airflow path of a fuel nozzle. The fuel nozzle auxiliary vane also includes a body extending from the vane mountable base, wherein the body comprises a fuel passage that turns from the fuel inlet to a fuel outlet, and the fuel outlet has a fuel outlet direction generally crosswise to a fuel inlet direction through the fuel inlet.

### BACKGROUND OF THE INVENTION

The subject matter disclosed herein relates to fuel nozzles for gas turbine engines. More particularly, the disclosed subject matter relates to premixers in fuel nozzles.

A gas turbine engine combusts a mixture of fuel and air to generate hot combustion gases, which in turn drive one or more turbines. In particular, the hot combustion gases force turbine blades to rotate, thereby driving a shaft to rotate one or more loads, e.g., electrical generator. As appreciated, a flame develops in a combustion zone having a combustible mixture of fuel and air. Unfortunately, the flame can potentially propagate upstream from the combustion zone into the fuel nozzle, which can result in damage due to the heat of combustion. This phenomenon is generally referred to as flashback. Likewise, the flame can sometimes develop on or near surfaces, which can also result in damage due to the heat of combustion. This phenomenon is generally referred to as flame holding. For example, the flame holding may occur on or near a fuel nozzle in a low velocity region. In particular, an injection of a fuel flow into an air flow may cause a low velocity region near the injection point of the fuel flow, which can lead to flame holding.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine engine, comprising a combustor, and a fuel nozzle disposed in the combustor, wherein the fuel nozzle comprises a first vane disposed in an airflow path, and a second vane protruding from a surface of the first vane, wherein a fuel flow path extends through the first and second vanes to a fuel port in the second vane, wherein the fuel port is directed into the airflow path.

In a second embodiment, a system includes a fuel nozzle auxiliary vane, comprising a vane mountable base comprising a fuel inlet, wherein the vane mountable base is configured to mount to a surface of a main vane disposed in an airflow path of a fuel nozzle, and a body extending from the vane mountable base, wherein the body comprises a fuel passage that turns from the fuel inlet to a fuel outlet, and the fuel outlet has a fuel outlet direction generally crosswise to a fuel inlet direction through the fuel inlet.

In a third embodiment, a fuel nozzle auxiliary vane includes a vane mountable base comprising a fuel inlet, wherein the vane mountable base is configured to mount to a main vane of a fuel nozzle, a body extending from the vane mountable base in a first direction, wherein the body comprises a closed face opposite of the vane mountable base, and the body comprising first and second tapered sides converging toward one another in a second direction crosswise to the first direction, and a fuel passage extending from the fuel inlet to a fuel outlet in the first tapered side.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 a schematic block diagram of an embodiment of an integrated gasification combined cycle (IGCC) power plant;

FIG. 2 is a cutaway side view of a gas turbine engine, as shown in FIG. 1, in accordance with an embodiment of the present technique;

FIG. 3 is a perspective view of a head end of a combustor of the gas turbine engine, as shown in FIG. 2, illustrating multiple fuel nozzles in accordance with certain embodiments of the present technique;

FIG. 4 is a cross-sectional side view of a fuel nozzle, as shown in FIG. 3, illustrating a premixer with swirl vanes and auxiliary vanes in accordance with certain embodiments of the present technique;

FIG. 5 is a perspective cutaway view of the fuel nozzle, taken within arcuate line 5-5 as shown in FIG. 4, illustrating an embodiment of the premixer with swirl vanes and auxiliary vanes;

FIG. 6 is a partial perspective cutaway view of the fuel nozzle, taken within arcuate line 6-6 as shown in FIG. 5, illustrating an embodiment of an auxiliary vane disposed on a swirl vane; and

FIGS. 7A, 7B, 7C, and 7D are perspective views of an embodiment of the auxiliary vane of FIG. 6.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In certain embodiments, as discussed in detail below, a gas turbine engine includes one or more fuel nozzles with compounded vanes, e.g., one vane disposed on another vane, to resist thermal damage associated with flashback and/or flame holding. In particular, each fuel nozzle may include a fuel-air premixer having a plurality of swirl vanes disposed in a circumferential arrangement in an air flow path, wherein each swirl vane includes at least one auxiliary vane configured to inject fuel into the air flow path. As discussed in detail below, each auxiliary vane may protrude outwardly from a surface of the swirl vane. In certain embodiments, each auxiliary vane has an airfoil shaped body, which generally aligns with a direction of the air flow path. In addition, the auxiliary vane may inject fuel into the air flow path in one or more directions. For example, the auxiliary vane may inject fuel in one or more radial directions, one or more axial directions, or one or more circumferential directions relative to a central axis of the fuel nozzle. In certain embodiments, the auxiliary vane may inject the fuel in one or more directions generally parallel to the air flow path. For example, the direction(s) of the fuel injection may be at least less than approximately 5, 10, 15, 20, 25, 30, 35, 40, or 45 degrees relative to the air flow path. Thus, the auxiliary vane and associated fuel injection may substantially reduce low velocity regions associated with the fuel injection, thereby substantially reducing the possibility of flame holding in the vicinity of fuel injection.

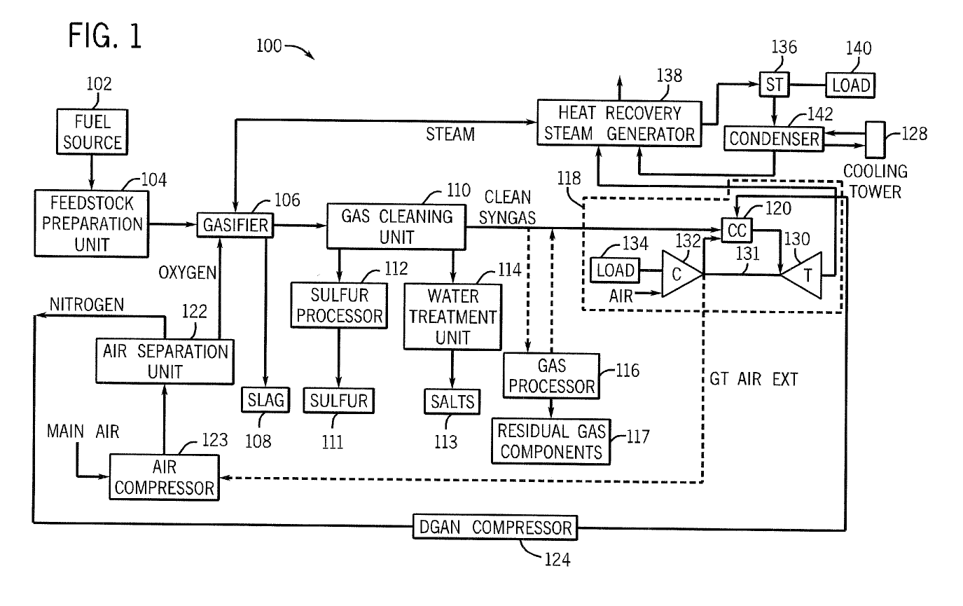

FIG. 1 is a diagram of an embodiment of an integrated gasification combined cycle (IGCC) system 100 that may be powered by synthetic gas, i.e., syngas. Elements of the IGCC system 100 may include a fuel source 102, such as a solid feed, that may be utilized as a source of energy for the IGCC. The fuel source 102 may include coal, petroleum coke, biomass, wood-based materials, agricultural wastes, tars, coke oven gas and asphalt, or other carbon containing items.

The solid fuel of the fuel source 102 may be passed to a feedstock preparation unit 104. The feedstock preparation unit 104 may, for example, resize or reshaped the fuel source 102 by chopping, milling, shredding, pulverizing, briquetting, or palletizing the fuel source 102 to generate feedstock. Additionally, water, or other suitable liquids may be added to the fuel source 102 in the feedstock preparation unit 104 to create slurry feedstock. In other embodiments, no liquid is added to the fuel source, thus yielding dry feedstock.

The feedstock may be passed to a gasifier 106 from the feedstock preparation unit 104. The gasifier 106 may convert the feedstock into a syngas, e.g., a combination of carbon monoxide and hydrogen. This conversion may be accomplished by subjecting the feedstock to a controlled amount of steam and oxygen at elevated pressures, e.g., from approximately 20 bar to 85 bar, and temperatures, e.g., approximately 700 degrees Celsius to 1600 degrees Celsius, depending on the type of gasifier 106 utilized. The gasification process may include the feedstock undergoing a pyrolysis process, whereby the feedstock is heated. Temperatures inside the gasifier 106 may range from approximately 150 degrees Celsius to 700 degrees Celsius during the pyrolysis process, depending on the fuel source 102 utilized to generate the feedstock. The heating of the feedstock during the pyrolysis process may generate a solid, (e.g., char), and residue gases, (e.g., carbon monoxide, hydrogen, and nitrogen). The char remaining from the feedstock from the pyrolysis process may only weigh up to approximately 30% of the weight of the original feedstock.

A combustion process may then occur in the gasifier 106. The combustion may include introducing oxygen to the char and residue gases. The char and residue gases may react with the oxygen to form carbon dioxide and carbon monoxide, which provides heat for the subsequent gasification reactions. The temperatures during the combustion process may range from approximately 700 degrees Celsius to 1600 degrees Celsius. Next, steam may be introduced into the gasifier 106 during a gasification step. The char may react with the carbon dioxide and steam to produce carbon monoxide and hydrogen at temperatures ranging from approximately 800 degrees Celsius to 1100 degrees Celsius. In essence, the gasifier utilizes steam and oxygen to allow some of the feedstock to be “burned” to produce carbon monoxide and energy, which drives a second reaction that converts further feedstock to hydrogen and additional carbon dioxide.

In this way, a resultant gas is manufactured by the gasifier 106. This resultant gas may include approximately 85% of carbon monoxide and hydrogen in equal proportions, as well as CH₄, HCl, HF, COS, NH₃, HCN, and H₂S (based on the sulfur content of the feedstock). This resultant gas may be termed dirty syngas, since it contains, for example, H₂S. The gasifier 106 may also generate waste, such as slag 108, which may be a wet ash material. This slag 108 may be removed from the gasifier 106 and disposed of, for example, as road base or as another building material. To clean the dirty syngas, a gas cleaning unit 110 may be utilized. The gas cleaning unit 110 may scrub the dirty syngas to remove the HCl, HF, COS, HCN, and H₂S from the dirty syngas, which may include separation of sulfur 111 in a sulfur processor 112 by, for example, an acid gas removal process in the sulfur processor 112. Furthermore, the gas cleaning unit 110 may separate salts 113 from the dirty syngas via a water treatment unit 114 that may utilize water purification techniques to generate usable salts 113 from the dirty syngas. Subsequently, the gas from the gas cleaning unit 110 may include clean syngas, (e.g., the sulfur 111 has been removed from the syngas), with trace amounts of other chemicals, e.g., NH₃ (ammonia) and CH₄ (methane).

A gas processor 116 may be utilized to remove residual gas components 117 from the clean syngas such as, ammonia and methane, as well as methanol or any residual chemicals. However, removal of residual gas components 117 from the clean syngas is optional, since the clean syngas may be utilized as a fuel even when containing the residual gas components 117, e.g., tail gas. At this point, the clean syngas may include approximately 3% CO, approximately 55% H₂, and approximately 40% CO₂ and is substantially stripped of H₂S. This clean syngas may be transmitted to a combustor 120, e.g., a combustion chamber, of a gas turbine engine 118 as combustible fuel. Alternatively, the CO₂ may be removed from the clean syngas prior to transmission to the gas turbine engine.

The IGCC system 100 may further include an air separation unit (ASU) 122. The ASU 122 may operate to separate air into component gases by, for example, distillation techniques. The ASU 122 may separate oxygen from the air supplied to it from a supplemental air compressor 123, and the ASU 122 may transfer the separated oxygen to the gasifier 106. Additionally the ASU 122 may transmit separated nitrogen to a diluent nitrogen (DGAN) compressor 124.

The DGAN compressor 124 may compress the nitrogen received from the ASU 122 at least to pressure levels equal to those in the combustor 120, so as not to interfere with the proper combustion of the syngas. Thus, once the DGAN compressor 124 has adequately compressed the nitrogen to a proper level, the DGAN compressor 124 may transmit the compressed nitrogen to the combustor 120 of the gas turbine engine 118. The nitrogen may be used as a diluent to facilitate control of emissions, for example.

As described previously, the compressed nitrogen may be transmitted from the DGAN compressor 124 to the combustor 120 of the gas turbine engine 118. The gas turbine engine 118 may include a turbine 130, a drive shaft 131 and a compressor 132, as well as the combustor 120. The combustor 120 may receive fuel, such as syngas, which may be injected under pressure from fuel nozzles. This fuel may be mixed with compressed air as well as compressed nitrogen from the DGAN compressor 124, and combusted within combustor 120. This combustion may create hot pressurized exhaust gases.

The combustor 120 may direct the exhaust gases towards an exhaust outlet of the turbine 130. As the exhaust gases from the combustor 120 pass through the turbine 130, the exhaust gases force turbine blades in the turbine 130 to rotate the drive shaft 131 along an axis of the gas turbine engine 118. As illustrated, the drive shaft 131 is connected to various components of the gas turbine engine 118, including the compressor 132.

The drive shaft 131 may connect the turbine 130 to the compressor 132 to form a rotor. The compressor 132 may include blades coupled to the drive shaft 131. Thus, rotation of turbine blades in the turbine 130 may cause the drive shaft 131 connecting the turbine 130 to the compressor 132 to rotate blades within the compressor 132. This rotation of blades in the compressor 132 causes the compressor 132 to compress air received via an air intake in the compressor 132. The compressed air may then be fed to the combustor 120 and mixed with fuel and compressed nitrogen to allow for higher efficiency combustion. Drive shaft 131 may also be connected to load 134, which may be a stationary load, such as an electrical generator for producing electrical power, for example, in a power plant. Indeed, load 134 may be any suitable device that is powered by the rotational output of the gas turbine engine 118.

The IGCC system 100 also may include a steam turbine engine 136 and a heat recovery steam generation (HRSG) system 138. The steam turbine engine 136 may drive a second load 140. The second load 140 may also be an electrical generator for generating electrical power. However, both the first and second loads 134, 140 may be other types of loads capable of being driven by the gas turbine engine 118 and steam turbine engine 136. In addition, although the gas turbine engine 118 and steam turbine engine 136 may drive separate loads 134 and 140, as shown in the illustrated embodiment, the gas turbine engine 118 and steam turbine engine 136 may also be utilized in tandem to drive a single load via a single shaft. The specific configuration of the steam turbine engine 136, as well as the gas turbine engine 118, may be implementation-specific and may include any combination of sections.

The system 100 may also include the HRSG 138. Heated exhaust gas from the gas turbine engine 118 may be transported into the HRSG 138 and used to heat water and produce steam used to power the steam turbine engine 136. Exhaust from, for example, a low-pressure section of the steam turbine engine 136 may be directed into a condenser 142. The condenser 142 may utilize a cooling tower 128 to exchange heated water for chilled water. The cooling tower 128 acts to provide cool water to the condenser 142 to aid in condensing the steam transmitted to the condenser 142 from the steam turbine engine 136. Condensate from the condenser 142 may, in turn, be directed into the HRSG 138. Again, exhaust from the gas turbine engine 118 may also be directed into the HRSG 138 to heat the water from the condenser 142 and produce steam.

In combined cycle systems such as IGCC system 100, hot exhaust may flow from the gas turbine engine 118 and pass to the HRSG 138, where it may be used to generate high-pressure, high-temperature steam. The steam produced by the HRSG 138 may then be passed through the steam turbine engine 136 for power generation. In addition, the produced steam may also be supplied to any other processes where steam may be used, such as to the gasifier 106. The gas turbine engine 118 generation cycle is often referred to as the “topping cycle,” whereas the steam turbine engine 136 generation cycle is often referred to as the “bottoming cycle.” By combining these two cycles as illustrated in FIG. 1, the IGCC system 100 may lead to greater efficiencies in both cycles. In particular, exhaust heat from the topping cycle may be captured and used to generate steam for use in the bottoming cycle.

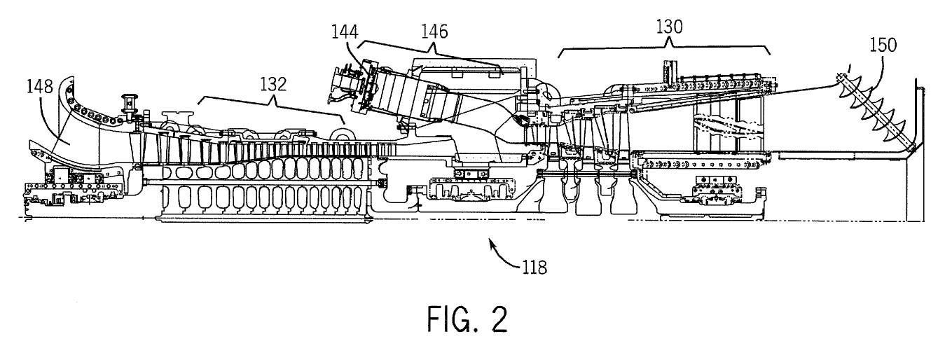

FIG. 2 is a cutaway side view of an embodiment of the gas turbine engine 118. The gas turbine engine 118 may use liquid and/or gas fuel, such as natural gas and/or a hydrogen rich syngas, to operate. The gas turbine engine 118 includes one or more fuel nozzles 144 located inside one or more combustors 146. As depicted, fuel nozzles 144 intake a fuel supply, mix the fuel with compressed air, discussed below, and distribute the air-fuel mixture into a combustor 146, where the mixture combusts, thereby creating hot pressurized exhaust gases. In one embodiment, six or more fuel nozzles 144 may be attached to the head end of each combustor 146 in an annular or other arrangement. Moreover, the gas turbine engine 118 may include a plurality of combustors 16 (e.g., 4, 6, 8, or 12) in an annular arrangement.

Air enters the gas turbine engine 118 through air intake 148 and may be pressurized in one or more compressor stages of compressor 132. The compressed air may then be mixed with gas for combustion within combustor 146. For example, fuel nozzles 144 may inject a fuel-air mixture into combustors in a suitable ratio for optimal combustion, emissions, fuel consumption, and power output. As discussed below, certain embodiments of the fuel nozzles 144 include swirl vanes with auxiliary vanes configured to substantially reduce low velocity regions associated with fuel injection into an air flow, thereby substantially reducing the possibility of flame holding in the region of fuel injection. The combustor 146 directs the exhaust gases through one or more turbine stages of turbine 130 toward an exhaust outlet 150, to generate power, as described above with respect to FIG. 1.

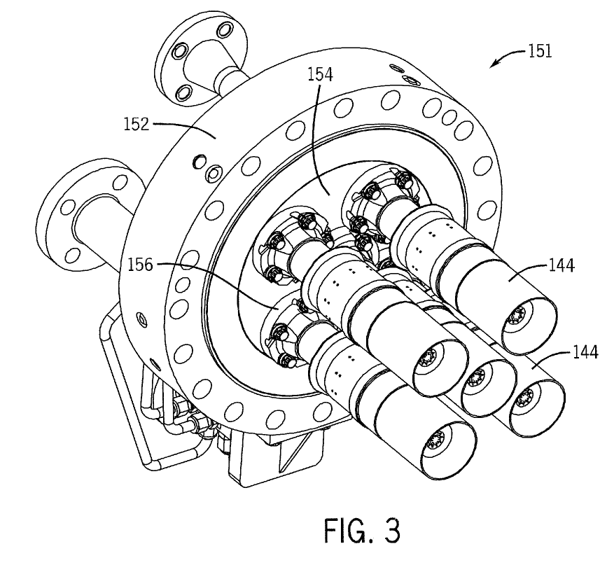

FIG. 3 is a detailed perspective view of an embodiment of a combustor head end 151 having an end cover 152 with a plurality of fuel nozzles 144 attached at a surface 154 via sealing joints 156. In the illustration, six fuel nozzles 144 are attached to end cover base surface 154 in an annular arrangement via joints 156. However, any suitable number and arrangement of fuel nozzles 144 may be attached to end cover base surface 154 via the joints 156. The head end 151 routes the compressed air from the compressor 132 and the fuel through end cover 152 to each of the fuel nozzles 144, which at least partially premix the compressed air and fuel as an air fuel mixture prior to entry into a combustion zone in the combustor 146. As discussed in further detail below, the fuel nozzles 144 may include one or more swirl vanes configured to induce swirl in an air flow path, wherein each swirl vane includes one or more auxiliary vanes configured to inject fuel into the air flow path. In particular, as discussed in detail below, each auxiliary vane may have an airfoil shaped body protruding outwardly from a surface of the swirl vane, wherein the airfoil shaped body may be oriented in alignment with the air flow path. Each auxiliary vane may include one or more fuel injection ports configured to inject fuel into the air flow path generally along the air flow path. In this configuration, the auxiliary vanes may substantially reduce low velocity regions associated with fuel injection directly from the surface of the swirl vane, thereby reducing the possibility of flame holding in the region of fuel injection.

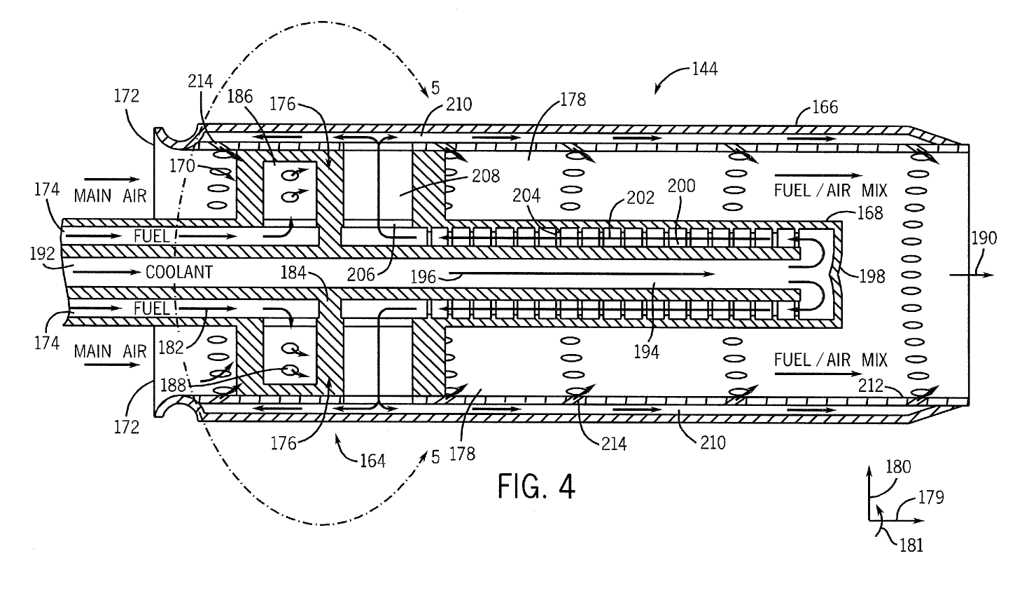

FIG. 4 is a cross-sectional side view of an embodiment of a fuel nozzle 144 having a unique airflow-aligned fuel injection arrangement 164, e.g., with auxiliary vanes 222, configured to reduce low velocity regions associated with fuel injection, thereby reducing the possibility of flame holding in the region of fuel injection. In the illustrated embodiment, the fuel nozzle 144 includes an outer peripheral wall 166 and a nozzle center body 168 disposed within the outer wall 166. The outer peripheral wall 166 may be described as a burner tube, whereas the nozzle center body 168 may be described as a fuel supply tube. The fuel nozzle 144 also includes a fuel/air pre-mixer 170 having an air inlet 172, a fuel inlet 174, swirl vanes 176, and an annular premixing passage 178 (e.g., annular passage for mixing fuel and air) between the wall 166 and center body 168. The swirl vanes 176 are configured to induce a swirling flow within the fuel nozzle 144. Thus, the fuel nozzle 144 may be described as a swozzle in view of this swirl feature. As discussed in further detail below, each swirl vane 176 may include one or more auxiliary vanes 222 protruding outwardly from a surface of the swirl vane 176 into the annular premixing passage 178.

It should be noted that various aspects of the fuel nozzle 144 may be described with reference to an axial direction or axis 179, a radial direction or axis 180, and a circumferential direction or axis 181. For example, the axis 179 corresponds to a longitudinal centerline or lengthwise direction, the axis 180 corresponds to a crosswise or radial direction relative to the longitudinal centerline, and the axis 181 corresponds to the circumferential direction about the longitudinal centerline.

As shown, fuel enters the nozzle center body 168 through fuel inlet 174 into fuel passage 182. Fuel impinges upon intermediate wall 184, whereupon it is directed radially into a vane passage 186 located within the swirl vane 176. In turn, the vane passage 186 directs the fuel through one or more fuel ports 188 into one or more auxiliary vanes 222, which then inject the fuel through fuel injection ports 224 into the annular premixing passage 178. Again, the auxiliary vanes 222 generally protrude from one or more surfaces of each swirl vane 176, and inject the fuel in a more aligned direction relative to the air flow through the annular premixing passage 178. In certain embodiments, the auxiliary vanes 222 may have an airfoil shape. At the same time, air is directed into the pre-mixer 170 through air inlet 172. As air passes over the airfoil shape of the swirl vanes 176 and the airfoil shape of the auxiliary vanes 222, it begins mixing with the fuel injected from one or more injection ports 224 and continues to mix within the annular premixing passage 178. The swirl vanes 176 may be angled and/or curved to impart a swirl to the flow. When the fuel-air mixture exits premixing passage 178, it enters a combustion zone 190, where combustion takes place. This aerodynamic design of the premixer 170 may be effective for mixing the air and fuel for low emissions and also for providing stabilization of the flame downstream of the fuel nozzle 144 exit in the combustion zone 190 of combustor 146.

Furthermore, the fuel nozzle 144 may introduce a coolant, such as air, into the center body 168 through a coolant inlet 192. Coolant travels axially 179 within cooling passage 194, as indicated by direction arrow 196, until it impinges upon the interior of an end wall 198, whereupon the coolant reverses flow and enters a reverse flow passage 200, as indicated by direction arrow 202. Reverse flow passage 200 is located concentric to cooling passage 194 and may contain a series of ribs 204 disposed along the reverse flow passage 200 to optimize and enhance heat transfer.

At the end of reverse flow passage 200 opposite from end wall 198, coolant is directed thorough opening 206 into chamber 208. Coolant passes through chamber 208 and into an annular cavity 210 defined between outer peripheral wall 166 and an interior tubular wall 212. A plurality of ports 214 located within the interior tubular wall 212 may be used to allow the coolant to form a film on interior tubular wall 212 (e.g., film cooling), protecting it from hot combustion gases. For example, the thin film of coolant (e.g., air) may act as a non-mixed barrier (i.e., no mixture of fuel and air) to block flame holding directly on the interior tubular wall 212. The thin film of coolant (e.g., air) also may convectively transfer heat away from the walls 166 and 212. In the illustrated embodiment, the fuel nozzle 144 directs the coolant (e.g., air) through the annular cavity 210 in both upstream and downstream axial directions 179 relative to the premixer 170, thereby providing cooling through ports 214 in the vicinity of the vanes 176.

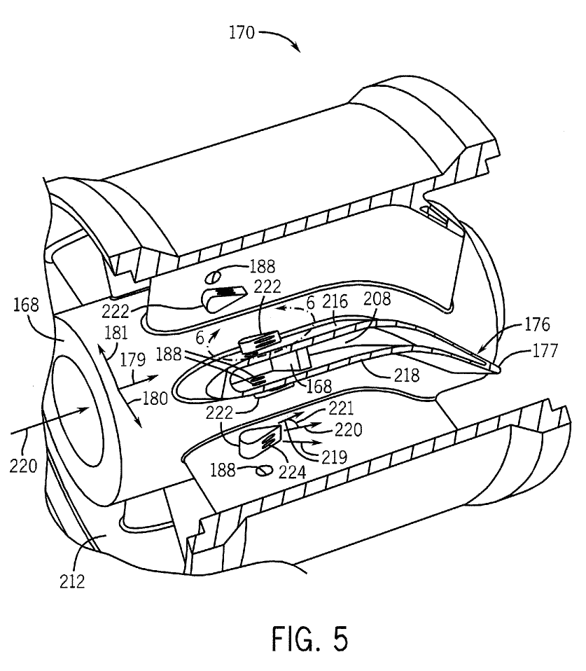

FIG. 5 is a perspective cutaway view of an embodiment of the premixer 170 taken within arcuate line 5-5 of FIG. 4. The pre-mixer 170 includes swirl vanes 176 disposed circumferentially 181 around the nozzle center body 168 such that the vanes 176 extend radially outward from the nozzle center body 168 to the inner tubular wall 212. As illustrated, each swirl vane 176 includes a hollow body, e.g., a hollow airfoil shaped body, having the vane passage 186 and the chamber 208. In addition, each swirl vane 176 includes a pair of auxiliary vanes 222 protruding from opposite first and second sides 216 and 218, wherein each swirl vane 176 has an airfoil shaped body with fuel injection ports 224. As discussed below, the auxiliary vanes 222 enable fuel injection in a plane parallel to the air flow 220, rather than crosswise (e.g., perpendicular) to the air flow 220. In certain embodiments, each auxiliary vane 222 turns the fuel flow over a turn of at least greater than or equal to 45, 60, 75, or 90 degrees. For example, each auxiliary vane 222 may include a 90 degree internal fuel passage. The auxiliary vanes 222 work in conjunction with the swirl vanes 176 to improve fuel-air mixing, while also reducing the possibility of flame holding in the region of fuel injection.

In the illustrated embodiment, the premixer 170 includes eight swirl vanes 176 equally spaced at 45 degree increments about the circumference of the nozzle center body 168. In certain embodiments, the premixer 170 may include any number of swirl vanes 176 (e.g., 2, 3, 4, 5, 6, 7, 8, 9, 10, 11, or 12) disposed at equal or different increments about the circumference of the nozzle center body 168. The swirl vanes 176 are configured to swirl the flow, and thus induce fuel-air mixing, in a circumferential direction about the axis 179. As illustrated, each swirl vanes 176 bends or curves from an upstream end portion 175 to a downstream end portion 177. In particular the upstream end portion 175 is generally oriented in an axial direction along the axis 179, whereas the downstream end portion 177 is generally angled, curved, or directed away from the axial direction along the axis 179. For example, the downstream end portion 177 may be angled relative to the upstream end portion 177 by an angle of approximately 5 to 60 degrees, or approximately 10 to 45 degrees. As a result, the downstream end portion 177 of each swirl vane 176 biases or guides the flow into a rotational path about the axis 179 (e.g., swirling flow). This swirling flow enhances fuel-air mixing within the fuel nozzle 144 prior to delivery into the combustor 146.

Additionally, one or more injection ports 224 may be disposed on the auxiliary vanes 222 over a fuel port 188 in the swirl vanes 176 at the upstream end portion 175. For example, these injection ports 224 may be approximately 1 to 100, 10 to 50, 20 to 40, or 24 to 35 millimeters (mm) in diameter. In one embodiment, the injection ports 224 may be approximately 40 to 50 mm in diameter. In another embodiment, the injection ports 224 may be approximately 0.25 to 1 mm in diameter. Each swirl vane 176 may include 1, 2, 3, 4, 5, 6, 7, 8, 9, 10 or more auxiliary vanes 222 on first and/or second sides 216 and 218, and each auxiliary vane 222 may include 1, 2, 3, 4, 5, 6, 7, 8, 9, 10 or more fuel injection ports 224. In some embodiments, the swirl vanes 176 may exclude auxiliary vanes 222 and injection ports 224 on the first side 216 or the second side 218. The first and second sides 216 and 218 may combine to form the outer surface of the swirl vane 176. For example, the first and second sides 216 and 218 may define an airfoil shaped surface as discussed above. In certain embodiments, each swirl vane 176 may include approximately 1 to 5 auxiliary vanes 222, each having 1 to 10 fuel injection ports 224. Each auxiliary vane 222 splits or divides the air flow 220 between a first air flow along the first side 216 and a second air flow along the second side 218, wherein the fuel injection ports 224 inject fuel into the air flow along the first and second sides 216 and 218.

Furthermore, each fuel injection port 224 may be oriented in an axial direction along the axis 179, a radial direction along the axis 180, and/or a circumferential direction along the axis 181 from one or more surfaces of each auxiliary vane 222. In other words, each fuel injection port 224 may have a simple or compound angle relative to a surface of the auxiliary vane 222, thereby inducing fuel-air mixing. In certain embodiments, each fuel injection port 224 may be oriented generally along the air flow path (e.g., arrow 220) between adjacent swirl vanes 176, e.g., generally along axis 179. In this manner, the auxiliary vanes 222 may substantially reduce low velocity regions upstream of the fuel injection (e.g., region 217), thereby substantially reducing the possibility of flame holding in the region of fuel injection. Otherwise, without the auxiliary vanes 222, the swirl vanes 176 may inject the fuel directly crosswise into the air flow 220, which could lead to particularly low velocity regions and greater potential for flame holding. Thus, instead of injecting the fuel directly from one or both of the surfaces 216 and 218 of the swirl vanes 176 (i.e., generally crosswise to the air flow 220), the auxiliary vanes 222 inject the fuel more in line, parallel, or along with the air flow 220. For example, the injection ports 224 may cause the fuel to flow into the air flow 220 between swirl vanes 176 at an angle of approximately 0 to 45, 5 to 30, or 10 to 20 degrees relative to the air flow 220, e.g., relative to axis 179. By further example, the fuel injection ports 224 may cause the fuel to flow into the air flow 220 at an angle of at least less than approximately 1, 2, 3, 4, 5, 6, 7, 8, 9, 10, 15, 20, 25, 30, 35, 40, or 45 degrees with respect to the air flow 220, e.g., relative to axis 179.

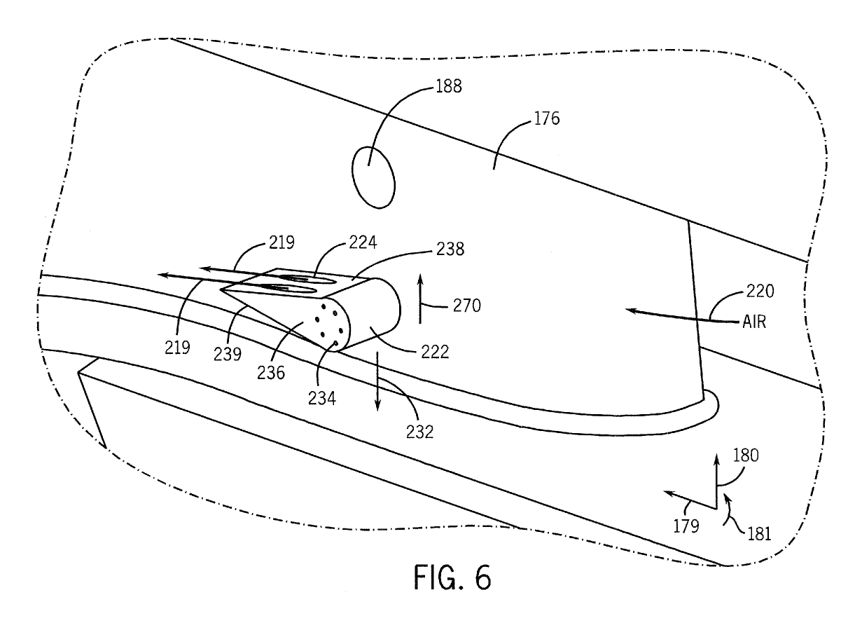

FIG. 6 is a partial perspective cutaway view of the fuel nozzle 144, taken within arcuate line 6-6 of FIG. 5, further illustrating an embodiment of the auxiliary vane 222 protruding from the swirl vane 176. As discussed further below, the auxiliary vanes 222 are configured to align the fuel injection with the air flow 220 to reduce low velocity regions associated with the fuel injection, thereby reducing the possibility of flame holding. As illustrated, the auxiliary vane 222 may extend circumferentially 181 outwards from the vane 176. The auxiliary vane 222, for example, covers the fuel port 188 to receive and redirect fuel through fuel injection ports 224. As the fuel passes through the fuel port 188 into the auxiliary vane 222 (i.e., along axis 181), it may be redirected axially 179 to flow downstream from the auxiliary vane 222 through fuel injection ports 224, e.g., in a direction indicated by direction arrow 219. As may be seen in FIG. 6, the flow of the fuel, that is, along line 219, is generally axially 179 parallel with the flow of air in the pre-mixer 170, indicated by directional arrow 220. In this manner, the fuel flowing along direction line 219 may not significantly intersect the air flowing along direction line 220 in a crossflow manner (e.g., 60 to 90 degrees), but rather, may combine to flow in a generally parallel direction with the air flow 220 in the pre-mixer 170. That is, the fuel flowing from the auxiliary vane 222 out fuel injection ports 224 may exit the auxiliary vane 222 in a substantially parallel manner to the arrow 220. In this manner, the fuel is redirected or turned approximately 90 degrees from the fuel port 188 to the fuel injection ports 224 prior to fuel injection into the air flow 220 in a downstream direction, as indicated by lines 219. Alternatively, the fuel injection ports 224 may be sized such that the fuel flows out of the auxiliary vane 222 at an angle relative to the air flow 220. For example, the fuel may flow out of the fuel injection ports 224 at an angle 221 of approximately 5, 10, or 15 degrees with respect the air flow 220 in the pre-mixer 170 as the fuel exits the auxiliary vane 222 and is injected into the pre-mixer 170.

Moreover, in an embodiment, the auxiliary vane 222 may be radially 180 adjustable. That is, the auxiliary vane 222 may be adjusted upwards and downwards, as indicated reference arrows 230 and 232. In other words, the auxiliary vane 222 may be rotated about an axis of the fuel port 188 via, for example a bolting mechanism (not pictured) that allows for axial movement of the auxiliary vane. In this manner, the fuel flowing out of the fuel injection ports 224 may intersect the air flow 220 along a specified angle 221 defined by the rotation of the auxiliary vane 222. For example, the auxiliary vane 222 may be adjusted approximately 5, 10, 15, or 20 degrees in an upward direction 230 such that the air flow 220 intersects the fuel flow 219 at an angle 221 corresponding to the rotation of the auxiliary vane 222. Alternatively, the auxiliary vane 222 may be adjusted approximately 5, 10, 15, or 20 degrees in a downward direction 232 such that the air flow 220 intersects the fuel flow 219 at an angle 221 corresponding to the rotation of the auxiliary vane 222. In certain embodiments, the auxiliary vane 222 may be rotated to different angles to adjust the turbulence and mixing of fuel and air in the premixer 170.

In some embodiments, one or more auxiliary vanes 222 may include peripheral injection outlets 234. The injection outlets 234 may be placed on a closed face 236 of the auxiliary vane 222 to vent pressure inside the auxiliary vane 222. For example, the injection outlets 234 may be placed in a circular arrangement along the closed face 236 of the auxiliary vane 222. However, other configurations are contemplated for the arrangement of the injection outlets 234. Fuel may flow from these injection outlets 234 and may intersect the air flowing across the vane 176 in a crossflow manner. In certain embodiments, the injection outlets 234 may be sized similar or different from the fuel injection ports 224. For example, the injection outlets 234 may be sized substantially smaller than the fuel injection ports 224. Thus, the overall crossflow of the fuel and air at this point due to the injection outlets 234 is not substantial enough to induce a low velocity recirculation zone behind the auxiliary vane 222. In certain embodiments, the injection outlets 234 may have a diameter of at least less than approximately 5, 10, 15, 20, 25, 30, 40, or 50 percent of a diameter of the fuel injection ports 224.

In the illustrated embodiment, the fuel injection ports 224 are placed on opposite sides 238 and 239 of the auxiliary vane 222. In some embodiments, one set of fuel injection ports 224 may be placed on only the side 238 or the side 239 of the auxiliary vane 222. Furthermore, while only one auxiliary vane 222 is illustrated in FIG. 6, it is envisioned that a second auxiliary vane 222 may be utilized covering the uncovered injection port 188 illustrated in FIG. 6. Accordingly, the number of auxiliary vanes 222 utilized in conjunction with the pre-mixer 170 may be changed, as desired to influence the fuel-air mixing attributes, as well as the overall pressure drop of the pre-mixer 170.

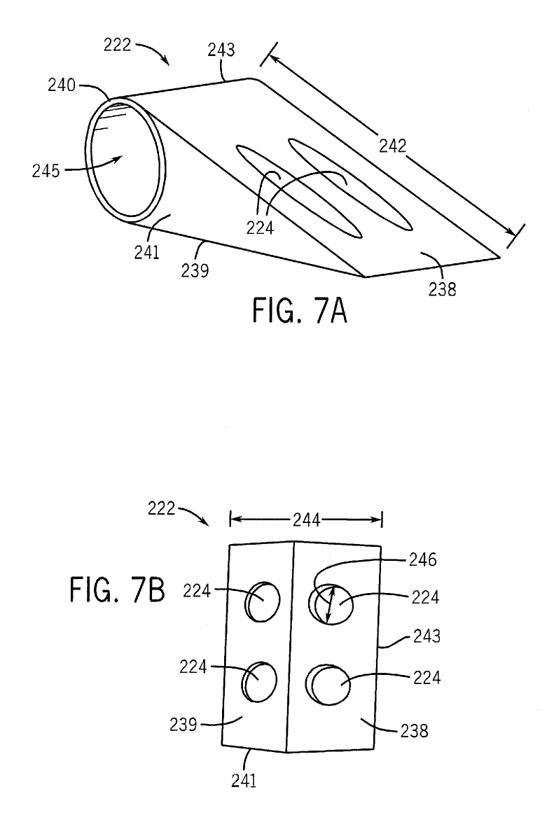

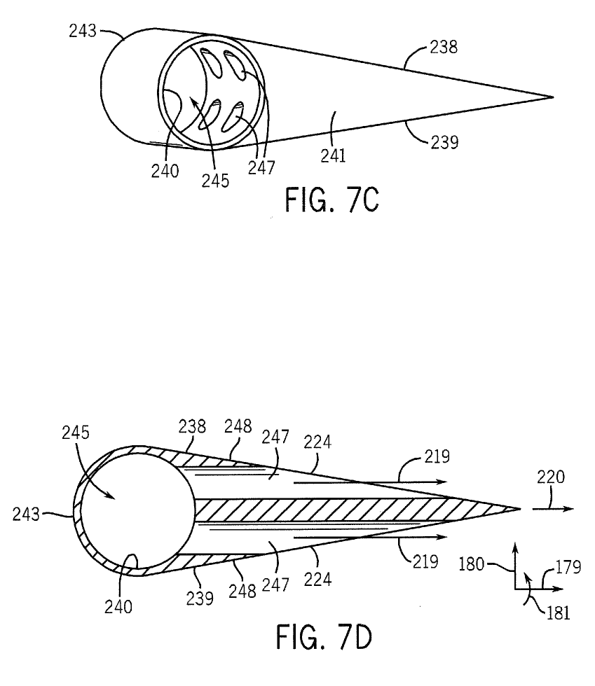

FIGS. 7A, 7B, 7C, and 7D are perspective views of an embodiment of the auxiliary vane 222 of FIG. 6. FIG. 7A illustrates a first perspective bottom view of auxiliary vane 222, FIG. 7B illustrates a front view of auxiliary vane 222, and FIG. 7C illustrates a second perspective bottom view of the auxiliary vane 222. As illustrated in FIG. 7A, the auxiliary vane 222 includes two fuel injection ports 224 disposed on the first side 238 of the auxiliary vane 222. Likewise, the auxiliary vane 222 may include two fuel injection ports 224 disposed on the second side 239. The auxiliary vane 222 also includes a fuel inlet port 240 configured to receive fuel from the fuel port 188 while mounted on the surface of the swirl vane 176, as discussed above. The auxiliary vane 222 includes a vane mountable base 241 and a body 243 extending from the vane mountable base 241, wherein the body 243 has an internal fuel passage 245 that turns the fuel flow from the fuel inlet port 240 to the fuel injection ports 224. For example, the fuel passage 245 may enable an internal fuel flow turn of approximately 90 degrees from the fuel inlet port 240 to the fuel injection ports 224.

The vane mountable base 241 may be coupled to the swirl vane 176 via a welded joint, one or more threaded fasteners, adhesives, or other fasteners. In some embodiments, the vane mountable base 241 may include a rotatable mount configured to enable rotational adjustment of the auxiliary vane 222 along the surface of the swirl vane 176. Upon reaching the desired angular position on the swirl vane 176, the vane mountable base 241 of the auxiliary vane 222 may be secured to the swirl vane 176. In certain embodiments, the auxiliary vane 222 and the swirl vane 176 may be formed as a one piece structure.

As illustrated in FIG. 7A, the shape of the auxiliary vane 222 may be an airfoil, oval, or teardrop shape. The overall length 242 of the auxiliary vane 222 may be sized at least less than approximately 1, 2, 3, 4, 5, 6, 7, 8, 9, 10, 15, 20, 25, or 30 percent of a length of the swirl vane 176. For example, the length 242 of the auxiliary vane 222 may be less than approximately 0.1, 0.2, 0.3, 0.4, 0.5, 0.6, 0.7, 0.8, 0.9, or 1 inch. In certain embodiments, the length 242 of the auxiliary vane 222 may be approximately 0.1 to 0.2 inches, or approximately 0.15 inches. It should be noted that the injection port 240 may be sized to cover the injection port 188 so that fuel may not seep into the pre-mixer 170 without passing first through the auxiliary vane 222 for redirection.

As further illustrated in FIG. 7A, the fuel injection ports 224 may be elliptical in shape along the first and second sides 238 and 239. As illustrated, the first and second sides are generally tapered or angled toward one another to define the airfoil shape. As a result, the elliptical shape of the fuel injection ports 224 may be attributed to the intersection of cylindrical internal fuel passages with the tapered first and second sides 238 and 239. In certain embodiments, the fuel injection ports 224 may have axes that are parallel to one another on the opposite first and second sides 238 and 239 of the auxiliary vane 222. In some embodiments, the fuel injection ports 224 may converge or diverge from one another on the opposite first and second sides 238 and 239 of the auxiliary vane 222. However, the fuel injection ports 224 may have any suitable geometry and configuration in various embodiments of the auxiliary vane 222.

The front view of the auxiliary vane 222 in FIG. 7B includes a measurement of the width 244 of the auxiliary vane 222. The overall width 244 of the auxiliary vane 222 may be sized at least less than approximately 1, 2, 3, 4, 5, 6, 7, 8, 9, 10, 15, 20, 25, or 30 percent of a width of the swirl vane 176. For example, the width 244 of the auxiliary vane 222 may be less than approximately 0.1, 0.2, 0.3, 0.4, 0.5, 0.6, 0.7, 0.8, 0.9, or 1 inch. In certain embodiments, the width 244 of the auxiliary vane 222 may be approximately 0.001 to 0.2 inches, 0.05 to 0.15 inches, or approximately 0.06 inches.

The diameter 246 across the fuel injection ports 224 may be, for example, less than approximately 0.005, 0.01, 0.015, 0.02, 0.03, 0.04, 0.05, 0.06, 0.07, 0.08, 0.09, or 0.1 inch. For example, the diameter 246 may range from approximately 0.005 inches to 0.02 inches, or may be approximately 0.01 inch. Furthermore, as previously illustrated in FIG. 7A, the fuel injection ports 224 may be elliptical in shape along the first and second sides 238 and 239. Accordingly, along the first and second sides 238 and 239, the width of the fuel injection ports 224 may be equal to the diameter 246 as described above, while the length of the fuel injection ports 224 may be, for example, approximately 2, 3, 4, 5, 6, 7, 8, 9, or 10 times the diameter 246. As illustrated in FIG. 7B, the fuel injection ports 224 are disposed on both the first and second sides 238 and 239. In some embodiments, the fuel injection ports 224 may be excluded on one of the sides 238 or 239.

FIG. 7C is a further illustration of the auxiliary vane 222 taken from a bottom perspective view. As illustrated in FIG. 7C, the fuel inlet port 240 leads into the internal fuel passage 245, which leads to internal fuel passages 247 of the fuel injection ports 224. Thus, inside the body 243 of the auxiliary vane 222, the internal fuel passages 245 and 247 turn the fuel flow by approximately 90 degrees from the fuel inlet port 240 to the fuel injection ports 224. Without these internal fuel passages 245 and 247, the fuel would inject into the air flow 220 in a crosswise direction rather than along the direction of the air flow 220. In other words, the auxiliary vane 222 channels and redirects (e.g., approximately 90 degree turn) the fuel flow to more closely align with the air flow 220. Thus, the auxiliary vane 222 provides an internal crosswise flow of the fuel from the injection port 240 to the fuel injection ports 224, thereby avoiding a similar crosswise flow of the fuel directly into the air flow 220. In other words, the auxiliary vane 222 guides the fuel flow into the air flow 220 for a more smooth transition or introduction into the air flow 220. In particular, the fuel flow passes through the inlet port 240 and along the internal fuel passage 245 until it impacts the closed portion 236, which (along with the body 243 of the auxiliary vane 222) channels the fuel to flow into and through the internal fuel passages 247 to the fuel injection ports 224. However, as described above, injection fuel outlets 234 may also be utilized in the closed portion 236 to allow reduction in pressure inside the internal fuel passage 245 of the auxiliary vane 222.

The incorporation of the auxiliary vanes 222 onto the swirl vanes 176, as opposed to swirl vanes 176 with fuel ports directly along their surfaces, may substantially reduce the pressure drop in the system. For example, the total pressure drop in the pre-mixer 170 may be reduced from, for example, approximately 35 pounds per square inch (PSI) to approximately 10 PSI. This pressure drop may for example, eliminate any recirculation/low velocity zone that could potentially harbor a flame during a flashback as described earlier. In this manner, the potential for a flame holding region upstream of auxiliary vane 222 may be substantially reduced. Furthermore, fuel and air mixing may be optimized for the pre-mixer 170 by adjusting the location of the auxiliary vane 222, the number of auxiliary vanes 222, the number of the fuel injection ports 224, and/or the size of the fuel injection ports 224 of the auxiliary vanes 222, as desired.

FIG. 7D is a side view of the auxiliary vane 222. As illustrated in FIG. 7D, the fuel inlet port 240 leads into the internal fuel passage 245, which leads to internal fuel passages 247 of the fuel injection ports 224. Thus, inside the body 243 of the auxiliary vane 222, the internal fuel passages 245 and 247 turn the fuel flow by approximately 90 degrees from the fuel inlet port 240 to the fuel injection ports 224, such that the fuel injection ports 224 are generally crosswise to the internal fuel passage 245, (e.g. a fuel inlet). Without these internal fuel passages 245 and 247, the fuel would inject into the air flow 220 in a crosswise direction rather than along the direction of the air flow 220. In other words, the auxiliary vane 222 channels and redirects (e.g., approximately 90 degree turn) the fuel flow along line 219 to more closely align with the air flow 220.

It is envisioned that the fuel passages 247 may be positioned at an angle relative to the axial axis 179. That is, the fuel passages 147 may be radially 180 positioned such that the fuel injection port 224 may be located at a point 248 on the first and second sides 238 and 239. In this manner, fuel flow may exit the fuel injection ports 224 at an angle relative to the air flow 220. This angle may be approximately, 5, 10, 15, 10, 25, 30, 35, 40, 45, 50, 55, 60, 65, 70, or 75 degrees from the airflow 220. Accordingly, dependent on the fuel air mixture characteristics desired, the fuel flow may exit the auxiliary vane 222 from passage 247 at an angle relative to the air flow 220.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine engine, comprising:
a combustor; and
a fuel nozzle disposed in the combustor, wherein the fuel nozzle comprises:
a first vane disposed in an airflow path; and
a second vane protruding from a surface of the first vane, wherein a fuel flow path extends through the first and second vanes to a fuel port in the second vane, wherein the fuel port is directed into the airflow path.

2. The system of claim 1, wherein the first vane is angled to provide swirl.

3. The system of claim 1, wherein the second vane comprises an airfoil.

4. The system of claim 3, wherein the second vane has a first fuel port along a first side and a second port along a second side, and the first and second sides are opposite from one another.

5. The system of claim 4, wherein the first and second fuel ports are elliptical along the first and second seconds.

6. The system of claim 4, wherein the first and second fuel ports have first and second fuel injection directions that are generally parallel to the airflow path.

7. The system of claim 1, wherein the second vane comprises a crossflow fuel port on a peripheral side of the second vane opposite from the surface of the first vane.

8. The system of claim 1, wherein the second vane is rotatable along the surface of the first vane.

9. A system, comprising:
a fuel nozzle auxiliary vane, comprising:
a vane mountable base comprising a fuel inlet, wherein the vane mountable base is configured to mount to a surface of a main vane disposed in an airflow path of a fuel nozzle; and
a body extending from the vane mountable base, wherein the body comprises a fuel passage that turns from the fuel inlet to a fuel outlet, and the fuel outlet has a fuel outlet direction generally crosswise to a fuel inlet direction through the fuel inlet.

10. The system of claim 9, comprising the main vane, wherein the main vane comprises a main airfoil shape having a downstream end portion that is angled relative to an upstream end portion along the airflow path.

11. The system of claim 10, comprising the fuel nozzle having the main vane and the fuel nozzle auxiliary vane, wherein the main vane extends radially from a central tubular body relative to an axis of the central tubular body, and the fuel nozzle auxiliary vane extends circumferentially from the main vane relative to the axis of the central tubular body.

12. The system of claim 11, comprising a turbine combustor having the fuel nozzle.

13. The system of claim 12, comprising a gas turbine engine having the turbine combustor.

14. The system of claim 9, comprising a crossflow fuel port on a peripheral side of the fuel nozzle auxiliary vane opposite from the vane mountable base.

15. The system of claim 9, wherein the fuel outlet direction is substantially parallel with the airflow path.

16. The system of claim 9, wherein the fuel nozzle auxiliary vane is rotatable at the vane mountable base.

17. A fuel nozzle auxiliary vane, comprising:
a vane mountable base comprising a fuel inlet, wherein the vane mountable base is configured to mount to a main vane of a fuel nozzle;
a body extending from the vane mountable base in a first direction, wherein the body comprises a closed face opposite of the vane mountable base, and the body comprising first and second tapered sides converging toward one another in a second direction crosswise to the first direction; and
a fuel passage extending from the fuel inlet to a fuel outlet in the first tapered side.

18. The fuel nozzle auxiliary vane of claim 17, wherein the vane mountable base and the body comprise an airfoil.

19. The fuel nozzle auxiliary vane of claim 17, wherein the closed face comprises a peripheral injection outlet configured to vent pressure inside the fuel inlet in the first direction.

20. The fuel nozzle auxiliary vane of claim 17, wherein the fuel outlet is oriented at approximately 90 degrees relative to the fuel inlet.
